(19) United States
(12) Patent Application Publication
(10) Pub. No.: US 2025/0299207 A1
(43) Pub. Date: Sep. 25, 2025

(54) UNIVERSAL ENTITY MAPPING AND INFERENCING SYSTEM

(71) Applicant: Microsoft Technology Licensing, LLC, Redmond, WA (US)

(72) Inventor: James Paul GYARMATHY, JR., Redmond, WA (US)

(21) Appl. No.: 18/609,769

(22) Filed: Mar. 19, 2024

(51) Int. Cl. G06Q 30/0201; G06N 5/04

(52) U.S. Cl. CPC G06Q 30/0201; G06N 5/04

(57) ABSTRACT

A data ingestion system generates an entity with a unique address and identifies a source system from which a signal is to be extracted. Entity data is read from the source system and stored in an entity structure which includes a unique address. A signal from the data source is read and classified to identify attributes of the entity. Each attribute of the entity is extracted and added to an attribute data structure which, itself, has a unique address that relates the attribute to the entity. The attribute data structure also includes a source identifier which identifies the source of the signal from which the attribute was obtained. As new signals are received from the data source, additional entity data structures (with unique addresses) can be added to the data store, and additional attribute data structures (with unique addresses) can be added to the existing entities without changing the existing entities themselves.

### BACKGROUND

Computing systems are currently in wide use. There are many different types and configurations of computing systems. Some are run locally while others are hosted for remote access.

While the present discussion relates to substantially any computer-accessible domain (e.g., services, products, resources, artificial intelligence (AI) models, buildings, materials, etc.), the background discusses services as an example only. Many different computing systems run a wide variety of different services. The services can be run in a single location or dispersed among a variety of different locations. Further, services are often configured into features or products that are offered to end users. The services also use resources which may be physical or virtual resources. The resources used by a service may also be located in different places.

Some organizations use a wide variety of different types of services. Other organizations offer a wide variety of different types of services for access by customers. These types of organizations often wish to perform various types of analysis on the services to determine how well the services are running, to determine how resources, services and features are interacting with one another, or simply to obtain an inventory of the organization's services, among other things. Such organizations often wish to analyze the resources, services, features, etc., in order to predict future states of those resources, services, features, etc.

The discussion above is merely provided for general background information and is not intended to be used as an aid in determining the scope of the claimed subject matter.

### SUMMARY

The present description describes an architecture that generates an inferencing model that models a computer-accessible environment, such as a remote server environment (e.g., the cloud). The inferencing model (also referred to as a predictive model) is generated using a structure that continuously ingests and evaluates signals from the environment over time while reducing costs associated with validating the signals.

In one example, a data ingestion system generates an entity with a globally unique address and identifies a source system from which data is to be extracted. Entity data is read from the source system and stored in an entity structure which includes a unique address. A data signal from the data source is read and classified to identify attributes of the entity. Each attribute of the entity is extracted and added to an attribute data structure which, itself, has a unique address that relates the attribute to the entity. The attribute data structure also includes a source identifier which identifies the source of the signal from which the attribute was obtained. As new signals are received from the source, additional entity structures (with unique addresses) can be added to the system, and additional attribute data structures (with unique addresses) can be added to the existing entities without changing the existing entities themselves.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1A illustrates a structure for generating an inference model.

FIG. 1B is a block diagram of one example of a mapping and inferencing system receiving a signal from a source and making it available to other systems.

FIG. 1C shows one example of how a signal is decoupled from its attributes.

FIG. 1D is a block diagram of one example of a mapping and inferencing system architecture.

FIGS. 2A and 3 show examples of data structures.

FIG. 2B shows an example of an entity structure.

FIG. 4 is a block diagram showing one example of an entity extraction system in more detail.

FIG. 5 is a block diagram showing one example of an attribute extraction system in more detail.

FIG. 6 is a block diagram of one example of a signal classification system.

FIG. 7 is a block diagram of one example of a relationship tracking system.

FIG. 8 is a block diagram of one example of an aggregation model.

FIGS. 9A and 9B (collectively referred to herein as FIG. 9) show a flow diagram illustrating one example of the operation of the data ingestion architecture.

FIG. 10 is a block diagram showing one example of the data ingestion architecture illustrated in FIG. 1, deployed in a remote server architecture.

FIG. 11 is a block diagram showing one example of a computing environment that can be used in the architectures and systems described above with respect to previous figures.

### DETAILED DESCRIPTION

The environment that people live in is filled with an abundance of sensory information (signals) having varying degrees of trustworthiness. The first order of trustworthiness for humans is the senses. However, humans have proven that even these senses can be deceived. There may also be multiple rings of sources where a human weights the quality of the signal against the trustworthiness of the sender and the coherence of the signal to the human world model.

Similarly, in large enterprise environments, specifically high-scale cloud computing, the system is inundated with an abundance of signals that are generally of poor quality and disjointed from other signals received. The typical enterprise approach has been to continually instantiate new systems and stores, generating new signals in a similar spectrum of quality. In addition, because these systems are created over time with various degrees of skill, attention, and focus, they deviate greatly from one another, costing further energy expenditure in consolidation, reconciliation, and redundancy. These aggregated signals are then provided back to the environment where they are consumed by other systems that create new signals, adding to the cacophony of noise in the environment. The typical solution to deal with this noise is to hire more humans to sift through this river of data in hopes of separating meaningful data from noise.

Also, systems must contend with conflicting and contradictory signals, and determine which source is likely providing the correct signal. In one example, conflicts can be resolved by choosing which sources and signals are most coherent with a current model of the environment. This can be achieved by identifying the source, tracking the source over time, and applying weights to the source as a proxy for the quality of the signal it provides. In order to do this, a source is uniquely identified by an immutable identifier. A source is identified prior to evaluating the accuracy of the signal emanating from it, and the weight of a signal is a factor of its source.

As discussed above, many organizations run different computing systems on different hardware, using different software. The computing systems can be distributed across different facilities and be used by different people, etc. Therefore, many organizations have difficulty inventorying entities across domains. An entity can be any identifiable item such as a piece of hardware or software, a facility, a person, an item of data, etc. Thus, many organizations do not know all of the services, resources, etc., that they are running and cannot track all of the entities. There is no central inventory of those items, which makes it difficult for organizations to track the entities, maintain the entities, manage the entities, and perform logistical or other operations relative to the entities.

Some current systems may attempt to build an integrated data model that represents all of the entities. However, this presents a number of difficulties. First, it is highly time consuming. Similarly, many different systems, that run the different services, have different ways of working and thus are modeled differently. Also, some services use patterns which can be modeled, but those patterns may change. Thus, even if an aggregated data model were generated, the model would soon be outdated because of changes to the underlying services.

Other current solutions focus on creating bespoke solutions for each domain (e.g., a hardware inventory system, a software inventory system, a facilities inventory system, different inventory systems for different countries, etc). Problems arise in keeping such solutions up to date and managing the fact that there are multiple ways to generate such solutions.

The present description thus describes a universal entity mapping and inferencing system which is a comprehensive system that identifies, catalogs, monitors, analyzes, and predicts various entities across multiple domains. The system utilizes a core structure that supports any entity inventory system, and enables transformation back to the original system structure, and facilitates overlaying multiple models across the same underlying structure.

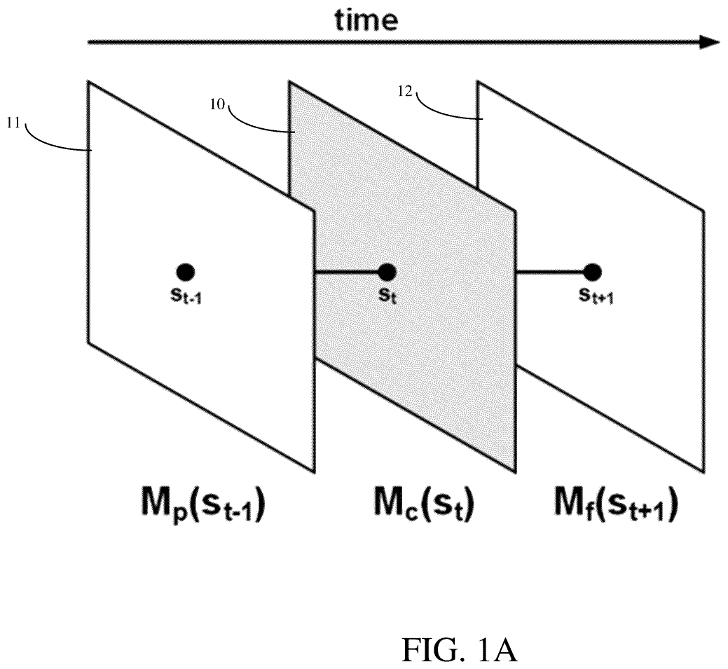

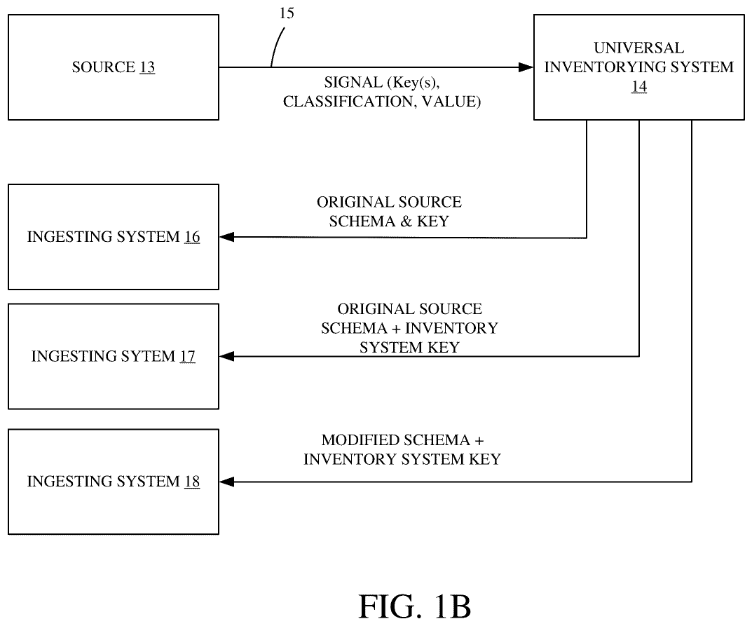

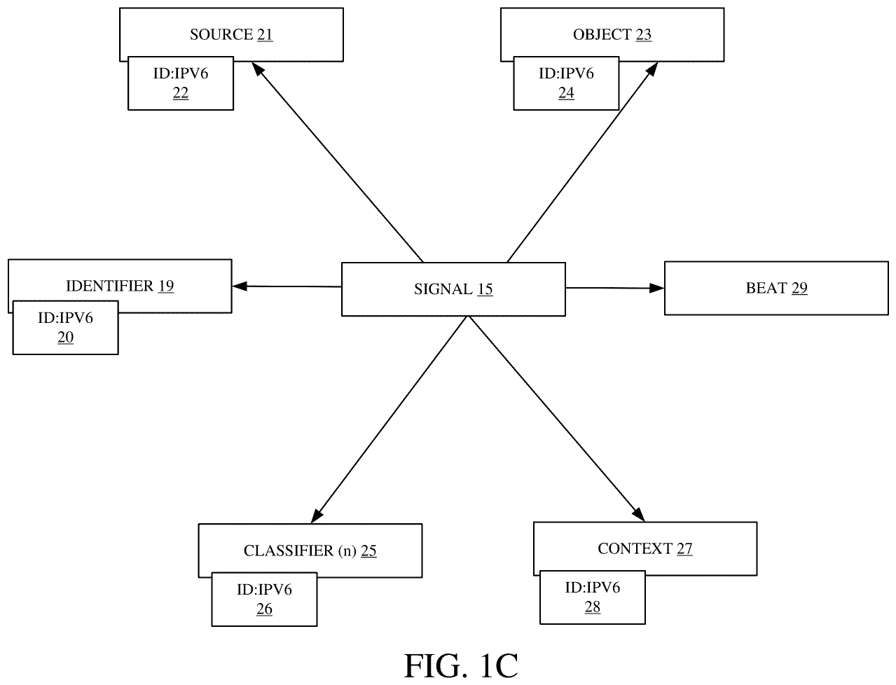

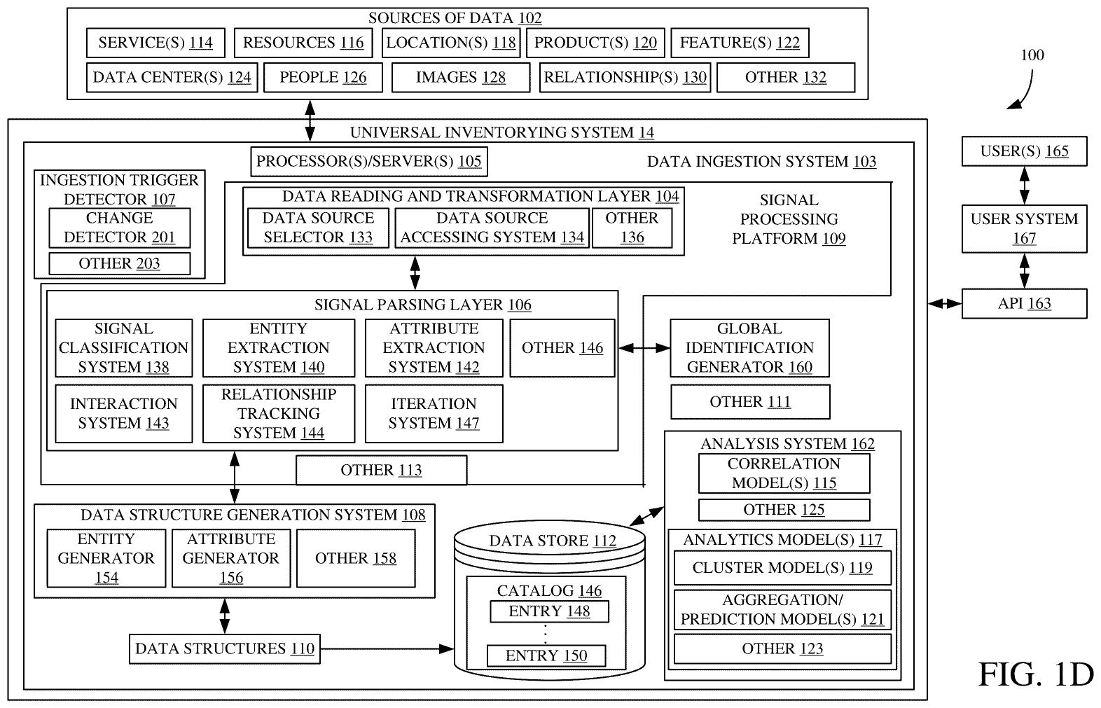

FIG. 1A shows one example of such a structure. The present system constructs a set of internal models (known as generative models) of the external environment to be inventoried. These models are essentially hypotheses about how sensory inputs are caused. These models enable the system to structure the massive amounts of signals it receives against an internal model of the expected state of the environment. The current state of the environment is represented by model 10 in FIG. 1A as denoted by M _{current} (S ₜᵢₘₑ). This current state model 10 has a complementary historical model 11 of all the previous states of the environment. The historical model 11 of the expected state of the environment is denoted by M ₚₐₛₜ (S ₜᵢₘₑ₋₁) with variable time decrements (e.g., seconds, days, years). These two models 10 and 11 are utilized to create a predictive model 12 of the expected future state of the environment, M _{future} (S _{time +1}). This structure enables a continuous ingestion and evaluation of signals over time (extending historical model 11), while minimizing the cost associated with determining the validity of a signal. The present description describes an architecture for generating an inferencing model (or predictive model 10) for the cloud.

More specifically, the present description describes an architecture that defines a user facing universal entity mapping and inferencing system that provides a unified solution to inventory and tracks any entity, regardless of the source system, reducing the need for costly bespoke inventory systems. This inferencing system greatly simplifies the challenge of inventory management by providing an efficient solution for generating the core features of any catalog (unique-id, ownership, attributes, and lifecycle) in a simplified, scalable, and distributed product. The inferencing system is applicable across domains (e.g., products, resources, AI models, buildings, materials, etc.) and is configurable with industry/domain templates that are either provided, custom made, or open-sourced. The inferencing system interacts seamlessly with existing inventory solutions and allows organizations to create a globally unique catalog of entities (originated, cloned, and shared), virtually unlimited attributes, and glossary across cloud and on-premises. Users can integrate with this catalog using the guaranteed globally unique address (creating stickiness) or an origination address depending on the desired scenario.

The present description thus describes a system that builds a catalog of entities and corresponding attributes based on signals from different domains that may be configured in vastly different ways. The present system distills data in the data sources down to a set of entities with attributes. A data structure is generated for each entity and each attribute, and each data structure has its own globally unique identifier (such as a unique address). Therefore, each entity and attribute can be accessed in the catalog, regardless of the system that sourced the entity and attribute. Also, entities can, themselves, be attributes of other entities and attributes, themselves, can be entities. By representing any complex data source as a set of unique entities and attributes, the present system reduces the need for any customized (bespoke) inventory tracking systems, as any entity, and any attribute, can be tracked, updated, correlated to other entities and attributes, or be identified and tracked in other ways, regardless of the source system from which the entity or attribute was cataloged.

FIG. 1B shows an architecture that further illustrates the universal inventorying system 14. FIG. 1B shows that inferencing system 14 receives a signal 15 is received from a source 13. The source signal 15 includes a key (or identifier) assigned by source 13, a classification, and a signal value. The inferencing system 14 described herein ingests the signal, transposes the signal into a known structure, extracts information from the signal, and decouples the source signal classification and other attributes from the source signal itself. This structure enables overlaying additional classifications and models while enabling transformation back to the original structure.

For example, assume that source 13 is an external system and signal 15 represents a table with a key (identifier) in source 13. System 14 saves information that allows system 14 to transform back to this original table structure. Additionally, any attribute can be logically renamed (to meet business or other requirements) as the classification (attribute name) is decoupled from the data value. This functionality is further illustrated with respect to FIG. 1B.

For instance, a plurality of ingesting systems 16, 17, and 18 are shown ingesting information from system 14. System 16 ingests the information using the original source schema (e.g., the table structure) and key (or identifier) used by source 13. System 17 ingests the information using the original source schema and key (or unique address) assigned by system 14. System 18 ingests the information according to a modified schema (which may be generated by an overlayed model or otherwise), using the key (or unique identifier) assigned by system 14.

Also, by way of example and as mentioned above, each item of data (each entity) obtained from the source system 13 may have corresponding metadata. The item is stored as an entity in the catalog in system 14 and the metadata is stored as attributes corresponding to the entity. However, the metadata is decoupled from the entity so that each item of metadata may have its own unique addresses (or key) which uniquely identifies that piece of metadata and also ties the piece of metadata back to the entity to which it was originally tied. Therefore, the inventory catalog generated by the system 14 includes a set of data structures, each with a unique address that identifies the data structure, itself, and also identifies relationships back to other data structures. The source 13 of the data represented by the data structure is also identified (e.g., using a source unique address or key) so that the data can be tied back to its source 13. In addition, where the item of data is sourced in multiple places, all of those different sources can be identified (e.g., using their unique addresses) in the data structure for the item.

FIG. 1C shows another example of how a signal is decoupled from its classification metadata (or attributes) by system 14. In FIG. 1C, the signal 15 has an identifier 19. Identifier 19 is decoupled from signal 15 and has its own unique address. Signal 15 also has a source identifier 21 which is also decoupled from signal 15 and given a unique address 22. Signal 15 may represent an object indicated in FIG. 1C by object 23 which is decoupled from signal 15 and given a unique address 24. Signal 15 may have one or more classifiers 25 that indicate how signal 15 is classified. Each attribute, from each source is classified, and each classification value 25 is given a unique address 26. Signal 15 may have additional context 27 which is decoupled from signal 15 and given its own unique address 28. Signal 15 may have a beat value 29 that identifies how recently (and perhaps how often) signal 15 was updated. All of the items 19, 21, 23, 25, 27, and 29 are decoupled from the signal 15 and items 19, 21, 23, 25, and 27 are each given a unique address.

When future signals are received from the data source, those signals can be read and classified to identify them as attributes and/or entities and the values of the attributes can be added to the attribute data structures without deleting older values. The recency value (beat) can be included to indicate how recently the signal was received or how recently the source of the signal was updated. Similarly, each entity and attribute may also store an identifier that is used to identify that entity or attribute in its source system. Thus, the entity or attribute can be accessed in the catalog by the unique address or by the identifier used in the source system. The attributes for an entity can be sharded into protected and sharable sets of attributes to create multiple, controlled views of the catalog. Thus, the entities can be extended with additional attributes and shared in different ways.

The unique address is a guaranteed globally unique address with assignable blocks to guarantee uniqueness across organizations and users. One example of a unique address is an internet protocol version 6 (IPv6) address.

This structure of assigning unique addresses enhances the ability of the system 14 to perform segmentation and enclaving by enabling external organizations (e.g., customers) to leverage this capability while ensuring uniqueness. Furthermore, leveraging this identifier enables Constellation to leverage an ecosystem of capabilities such as to deterministically translate between identifiers to enhance operations.

As mentioned above, a catalog entity can be associated (linked) with a secondary (non-cloned) source to enable customers to integrate separate sources of the same entity type to the authoritative entity source. The scenario can occur, for example, when different parts of an organization create “authoritative” sources with unique but different keys (identifiers).

Because there may be signals from a plurality of different sources that relate to the same object or entity, the signals are classified on a per-attribute, per-source basis. Signals from multiple sources related to the same entity or object are identified as relating to the same entity or object and filtered based on a set of criteria (timeliness, usage, accuracy, etc.). The signals can also be filtered using machine learning algorithms to identify things such as the accuracy of each signal, the deviation among the different signals, etc.

It will also be noted that when generating a catalog of inventoried items, catalog objects can be cloned (copied) from the original source to the newly created catalog. The clone function can be implemented as a wrapper around database pipeline resources that simplifies the process of cloning data from the source.

The key(s) (identifiers) from the source are added as an attribute and identified with a special type value (i.e., an address type or a key type). This enables users to retrieve catalog objects by the “Global Id” (the unique address assigned by system 14) or the “Source Id” (the identifier used by the source system) to enable compatibility with existing systems and forward integration with new systems. In one example, system 14 will, internally to the catalog, only use the “Global Id”.

Enabling customers to link existing sources to the authoritative source facilitates a smooth transition of existing systems. For example, since an API exposed by the catalog supports access by the Global-Key or any Associated-Key the first steps in this migration can be simply accessing the authoritative attributes from the catalog.

Further, system 14 generates the catalog according to an architecture which implements a sharding pattern that is distributed across public, private and enclave boundaries. This sharding allows an organization to generate an extension that extends a catalog object to meet scenarios of the organization privately and then share that extension out to the original owner of the object or other systems as needed, enabling fine-grained data ownership.

Further, catalog objects all have a common structure. The common structure across catalog objects enables organizations to join together multiple objects into virtual objects. The virtual objects thus provide a single view across multiple shards. This can be utilized for multiple scenarios including searching across enclave and “public” data, performance optimization for local/edge and remote data, separating operational data in high-performance, hot storage with shorter retention periods, and creating and storing periodic time-series data in cold storage for compliance and security scenarios, among others.

FIG. 1D is a block diagram of one example of a mapping and inferencing system architecture 100 in which data can be ingested by system 14 from one or more sources of data 102 into a catalog 146 using data ingestion system 103. FIG. 1 also shows that one or more users 165 can use user computing system 169 to access data ingestion system 183 and catalog 146 through an application programming interface (API) 163 exposed by data ingestion system 103 and/or data store 112, which stores catalog 146.

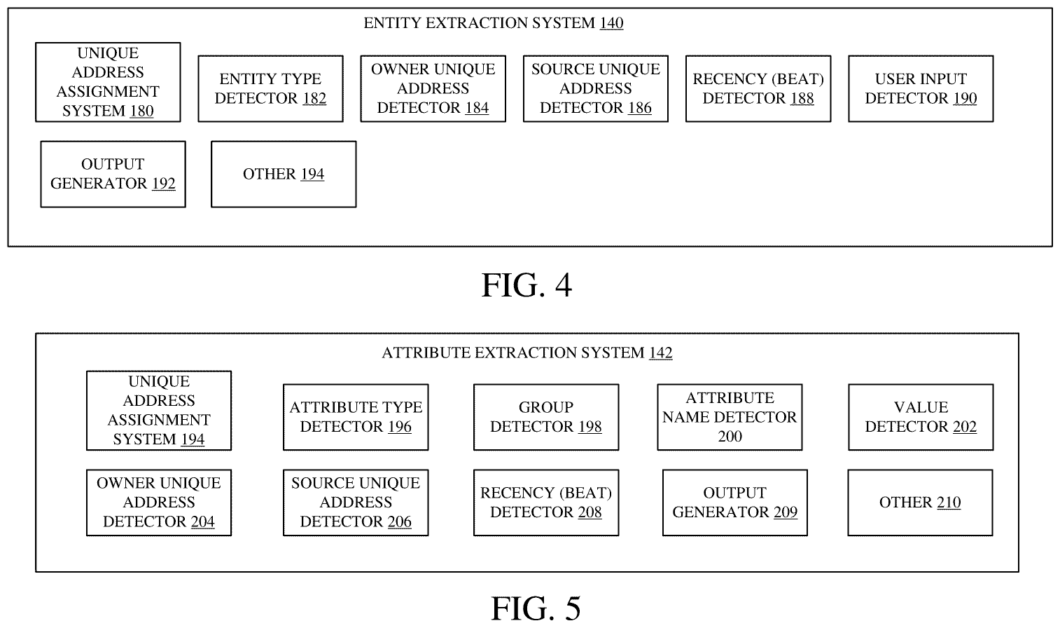

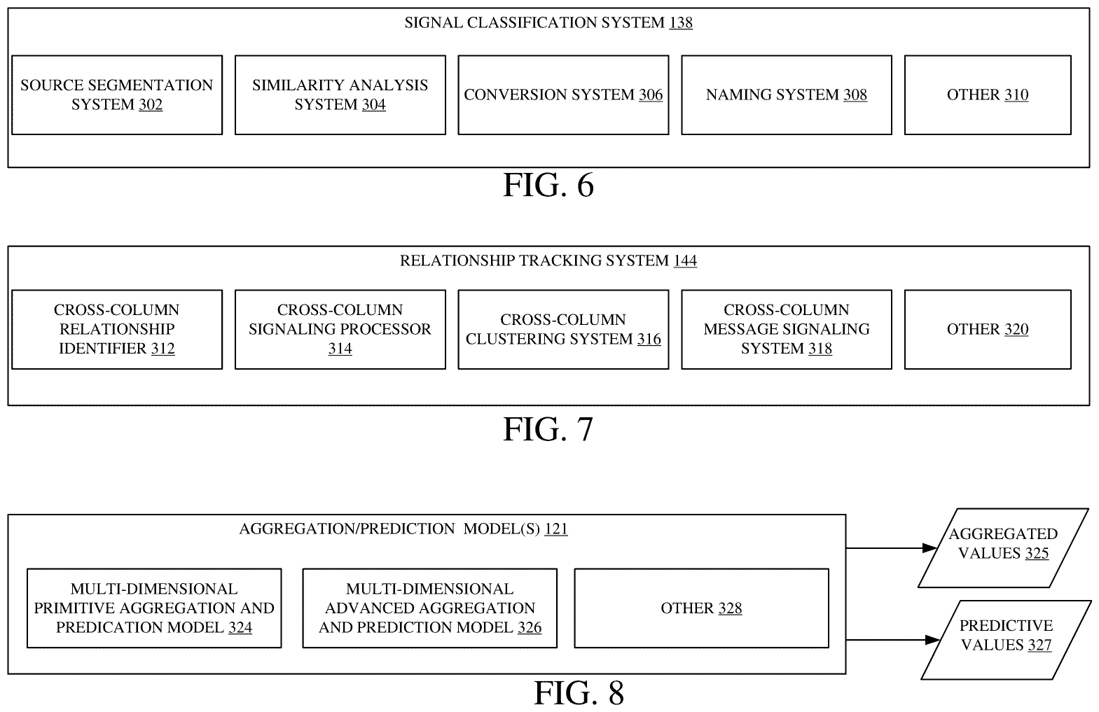

Data ingestion system 103 can include one or more processors or servers 105, ingestion trigger detector 107 (which can include change detector 201 and other items 203), signal processing platform 109, and data structure generation system 108. Data ingestion system 103 can also include global identification generator 160, data store 112, analysis system 162, and other items 111. Data processing platform 109 can include data reading and transformation layer 104, signal parsing layer 106, and other items 113. Data reading and transformation layer 104 can include data source selector 133, data source accessing system 134, and other items 136. Signal parsing layer 106 can include signal classification system 138 (also described below with respect to FIG. 6), entity extraction system 140 (also described below with respect to FIG. 4), attribute extraction system 142 (also described below with respect to FIG. 5), interaction system 143, relationship tracking system 144 (also described below with respect to FIG. 7), iteration system 147, and other items 146. Data structure generation system 108 can include entity generator 154, attribute generator 156, and other items 158. Analysis system 162 can include correlation models 115, analytics models 117, (which can include cluster models 119, aggregation/prediction models 121 (also described below with respect to FIG. 8), and other models 123), as well as other functionality 125.

Data reading and transformation layer 104 reads data from data sources 102 and provides the data to signal processing layer 106. Signal processing layer 106 parses the signals read from data sources 102 to identify entities and attributes and decouple the entities from the attributes, which are provided to data object structure generation system 108. System 108 generates data structures 110 which are stored, as catalog entries (e.g., entries 148-150) in data store 112. As discussed below, the catalog entries 148-150 can be extended over time. Therefore, the catalog entries 148-150 represent the current state model (represented by model 10 in the structure described above with respect to FIG. 1A) as well as the historical state model (represented by model 11 in the structure described above with respect to FIG. 1A). Before describing the overall operation of architecture 100 in more detail, a description of some of the items in architecture 100, and their operation, will first be provided.

Sources of data 102 may include sources of data that implement or describe services 114, resources 116, locations 118, products 120, features 122, data centers 124, people 126, images 128, relationships 130, and any of a wide variety of other sources of data 132. The sources of data 102 may be overlapping or correlated or configured to operate with one another. For instance, services 114 may use resources 116 that are located at different locations 118. Features 122 may be different configurations of services 114 and offered through products 120.

Ingestion trigger detector 107 detects a trigger indicating that a signal is to be ingested from a data source 102. The trigger can be a manual trigger, a time-based trigger, a change-based trigger (e.g., change detector 201 which detects that a signal from a data source 102 represents a change to a catalog entry), etc.

Data accessing system 134 can be specifically configured to read data (e.g., receive a signal) from a data source 102 based upon the particular data source 102 from which the signal is being received. Data accessing system 134 can also include a source-independent data accessing system that exposes an interface through which the data sources 102 can inject signals.

The signal is then provided to signal parsing layer 106. Signal classification system 138 can include a large language model (LLM) or other classifier that receives a data signal from data reading and transformation layer 104 and classifies that signal in a number of ways, including to determine whether the signal should give rise to the creation of an entity and/or an attribute of an entity. For example, the signal can be filtered or processed based on its source, its similarity to other entities, etc. If the signal gives rise to another entity or attribute in the catalog, that entity or attribute is converted to the common catalog structure and named. Entity extraction system 140 extracts at least a minimum set of data from the signal for the creation of an entity data structure and attribute extraction system 144 extracts at least a minimum set of data for the creation of an attribute data structure. Interaction system 143 facilitates interaction with catalog 146 to extract information for searching, comparisons of newly received data to stored data, etc. Relationship tracking system 144 determines whether the newly received signal is related to other entities or attributes. For example, relationship tracking system 144 can compare entities, across columns of the common structures, to identify related entities and to identify signals that affect related entities. Relationship tracking system 144 can cluster data across columns and track and control cross-column messaging by which entities interact with or affect one another. For instance, relationship tracking system 144 may determine that the signal is an attribute value that should be added as an attribute of an already-existing entity. The instruction to generate an entity data structure or an attribute data structure, along with the extracted data, is then passed to data structure generation system 108. Data structure generation system 108 then generates or modifies data structures 110 so that those data structures 110 can be stored as entries 148-150 in inventory catalog 152 in data store 112. Entity generator 154 generates an entity data structure while attribute generator 156 generates an attribute data structure. Other items 158 can be used to generate other data structures as well.

FIG. 1D also shows that architecture 100 includes global identification generator 160 and analysis system 162. Global identification generator 160 generates a globally unique address such as a GUID or IPV6 address for the different entities and attributes so that they can be individually accessed using the unique address. Analysis system 162 can analyze entries 148-150 in catalog 112 to identify relationships among different entries in catalog 152, and to produce other metrics based on values in the various entries 148-150. Such analysis can be performed by relationship tracking system 144 and/or by analysis system 162. For instance, correlation model(s) 115 may identify correlations between different entities or attributes and other entities or attributes. Models 115 may be artificial intelligence (AI) models, such as LLM(s), or rules-based models or other models. Cluster models 119 may also be AI models trained to cluster similar data together so that similar data structures in catalog 146 can be clustered together. Such models may be for example, networks that generate embeddings for the data structures in vector space and generate clusters using an approximate nearest neighbor algorithm or another process.

Aggregation/prediction models 121 can compute metrics on values in catalog 146 and generate aggregations of the metrics. Models 121 can be generative AI systems, such as LLMs, machine learned systems, and/or rules-based systems. Aggregation/prediction models 121 can generate primitive or more advanced aggregations by using the outputs of the other models to identify correlated or clustered data structures and generate aggregations on the values in correlated or clustered data structures, for instance. In one example, the aggregations can be multi-dimensional aggregations, such as aggregations across entities, attributes, sources, granularity, and time or other dimensions. Aggregation/prediction model 121 can use the current and historical values in catalog 146, as well as the correlations, clusters and aggregations, to generate predicted signal values for a future time period or state. The predicted signal values can be embodied in a model or in additional catalog entries. Thus, the aggregation/prediction models 121 and/or the values generated by models 121 represent the inference or predictive models (represented by model 12 in FIG. 1A).

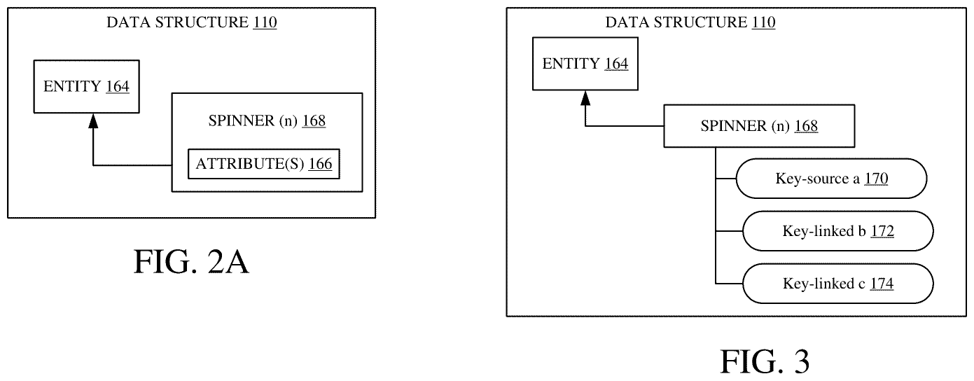

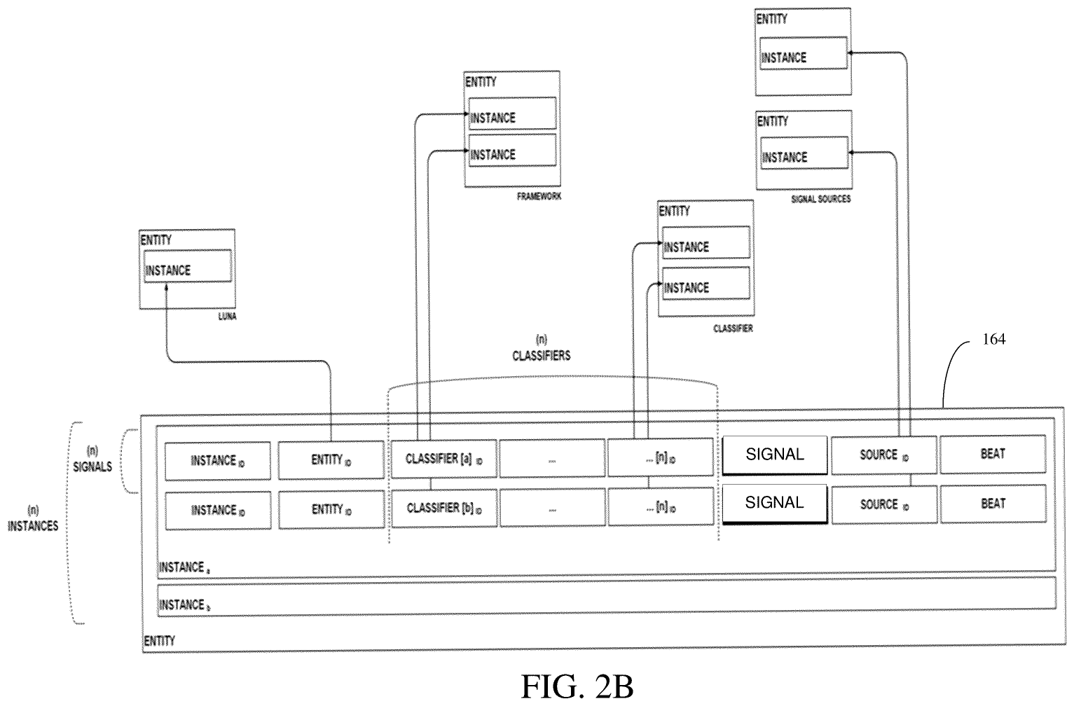

FIG. 2A shows one example of a data structure 110 for an entity 164 with associated attributes 166. In the example shown in FIG. 2A, attributes 166 are collectively stored in a data structure referred to as a spinner 168.

Entities are, for example, singular, identifiable and separate objects. An entity can also be, for example, a person, organization, system, system component, or distinct bits of data. In a database, an entity may be an individual thing such as a person, a table, concept, or object. An entity has an attribute. An attribute is a property of an entity. However, an attribute may also, itself, be an entity. For instance, an entity may be an image. That image may be an image of a cat. Thus, cat is an attribute of the image but may also be an entity, itself. Therefore, iteration system 147 can iterate over the attributes to determine whether the attributes are also entities for which entity data structures can be generated. Entities and attributes can be identified in a signal or other data source using a classifier, a rules-based system, or another model or system.

FIG. 2B shows one depiction of data stored in an entity data structure 164. The entity data structure 164 contains a minimum amount of data that is the same across all different types of entities. This common data structure enables rapid creation, integration, and use of the entity data structure. It can be seen in FIG. 2B that the entity data structure can have multiple instances. Instanceₐ and Instance_{b} are shown by way of example only. Each instance may be based on one or more signals and each signal may be parsed or decoupled into an instance identifier, an entity identifier, a set of classifiers, values, a source identifier, a beat value, and/or other values. The entity identifier may link to other instances in other entities. The classifier values may link to instances in other entities as well. Similarly, the source identifier identifies a source of the signal.

It will be noted that the attributes can be stored in a single spinner or multiple spinners which may be divided into shards based upon user scenarios. The attributes 166 in a spinner 168 can be sourced locally, cloned from a single source 102, or from multiple sources 102.

It should also be noted that, in some systems (and as described above), there may be a plurality of different data sources for a given entity. In such systems, the entity structure 164 includes the unique address for the authoritative source. However, the entity structure 164 may also be linked to other sources using the unique addresses for those sources. FIG. 3 shows one example of this. In FIG. 3, spinner 168 not only includes the key value (unique address) 170 for the authoritative source of entity 164, but also includes the key values (unique addresses) 172 and 174 that link entity 164 to other sources.

FIGS. 4-8 show more detailed examples of the functionality in signal parsing layer 106 and analysis system 162. Before continuing with that description, it will be noted that the functionality described in one block in FIG. 1D may be performed, instead, by another block in FIG. 1D. Therefore, FIGS. 4-8 may show that some functionality is performed by multiple different blocks. However, the functionality need not be duplicated, and the descriptions of FIGS. 4-8 are simply meant to show that similar or different functionality can be performed by the different blocks described. The functionality can be distributed in other ways, or aggregated differently as well.

FIG. 4 is a block diagram showing one example of entity extraction system 140 in more detail. In the example shown in FIG. 4, entity extraction system 140 decouples the received signal from its attributes and extracts data needed to create an entity data structure as an entity in catalog 146. Entity extraction system 140 includes unique address assignment system 180, entity type detector 182, owner unique address detector 184, source unique address detector 186, recency (beat) detector 188, user input detector 190, output generator 192, and other items 194. Unique address assignment system 180 interacts with global identification generator 160 to obtain an IPV6 address or GUID (or other unique address) for the entity that is being generated. Entity type detector 182 detects the type of entity (such as numeric, textual, code, etc.). Owner unique address detector 184 detects the unique address for the owner of the entity and source unique address detector 186 detects the unique address for the source of the entity. Recency detector 188 detects the last update date or update frequency (beat) for the entity. User input detector 190 can also detect user inputs (such as through API 163) that allows a user to generate a human readable description of the entity as well as a name of the entity, etc.

Output generator 192 generates an output to data structure generation system 108. The output includes the data and identifies the type of data structure (entity, attribute, etc.) that is to be generated. Entity generator 154 can receive an input from signal parsing layer 106 and generate the data structure corresponding to the entity based upon the information received. Entity generator 154 can, for instance, generate data structure 110 as an array or another data structure.

FIG. 5 is a block diagram showing one example of attribute extraction system 142 in more detail. In the example shown in FIG. 5, attribute extraction system 142 includes unique address assignment system 194, attribute type detector 196, group detector 198, attribute name detector 200, value detector 202, owner unique address detector 204, source unique address detector 206, recency detector 208, output generator 209, and other items 210. Unique address assignment system 194 interacts with global identification generator 160 to obtain an IPV6 address or a GUID (or other unique address) for the attribute being generated. Attribute type detector 196 detects the type of attribute (e.g., numeric, string, etc.). Group detector 198 may detect a group to which the attribute belongs. Attribute name detector 200 detects a unique name for the attribute and value detector 202 detects the value of the attribute. Owner unique address detector 204 detects the unique address identifying the entity of the owner of the attribute and source unique address detector 206 detects the unique address corresponding to the source of the attribute. Recency (beat) detector 208 detects the last update time or update frequency (beat) when the attribute value was updated. Output generator 209 generates an output of the information to be used in generating the attribute data structure (or spinner) which can be included in the spinner corresponding to entity 164.

FIG. 6 is a block diagram showing one example of signal classification system 138 in more detail. In the example shown in FIG. 6, signal classification system 138 is configured to segment the signal, by source, analyze other similar signals, convert the signal into the common structure of the catalog entries 148-150 in the catalog, and generates a name for the catalog entry. Therefore, in the example shown in FIG. 6, signal classification system 138 includes source segmentation system 302, similarity analysis system 304, conversion system 306, naming system 308, and other items 310. Source segmentation system 302 filters the signal based on its source. Similarity analysis system 304 identifies similar signals from other sources. Conversion system 306 converts the signal into the standard structure used for entries in the catalog. As discussed above, systems 302-308 can be generative AI systems, such as LLMs, other machine learned systems, rules-based systems, etc.

FIG. 7 is a block diagram showing one example of relationship tracking system 144 in more detail. In one example, each entry in the catalog 146 can be viewed as a column of data representing an entity, attributes, etc. Each item of data in the column may be related to items of data in other columns in other catalog entries. Thus, when a signal affects the value of an item of data in a particular column of a catalog entry in catalog 146, that signal may also affect the value of the items of related data in other columns. Further, based upon the relationships between catalog entries, items of data may be clustered, in a cross-column fashion, based upon their relationships, so that similar items of data are clustered together in vector space, or in another space. Further, messages generated corresponding to an item of data in one column may also be intended for items of data in other columns. Therefore, relationship tracking system 144 identifies cross-column relationships and processes signals and messages based on those relationships, and also clusters items of data based on those relationships.

In the example shown in FIG. 8, relationship tracking system 144 includes cross-column relationship identifier 312, cross-column signaling processor 314, cross-column clustering system 316, cross-column message signaling system 318, and other items 320. The items in relationship tracking system 144 can be generative AI systems, such as LLMs, machine learning systems, rules-based systems, or other systems that perform cross-column data processing. Cross-column relationship identifier 312 identifies relationships, across columns, in the catalog entries. The relationships can be identified based on a wide variety of different types of relationship criteria or based on classification values generated by generative LLMs, or in other ways. Cross-column signaling processor 314 processes related data items, across columns, based upon signals that affect one of the related data items. Therefore, if a signal affects one of the related data items, cross-column signal processor 314 identifies other related data items in other columns that may be affected by the signal, and processes those data items based on the signal as well. Cross-column clustering system 316 performs clustering based upon cross-column, related data items. Cross-column message signaling system 318 processes messages based upon the relationships across the columns.

FIG. 8 is a block diagram showing one example of aggregation/prediction models 121 in more detail. It will be appreciated that aggregation/prediction models 121 can perform aggregations of values in the various catalog entries to generate aggregated values 325. The aggregations can be relatively primitive aggregations or complex aggregations. Further, based upon current and historical values corresponding to a signal and/or based upon the current and historical aggregations, the aggregation/prediction models 121 can generate predictive values 327 as an inference model. Aggregation/prediction models 121 thus predict future states of the environment from which signals are processed. It will also be appreciated that the aggregations can be multi-dimensional aggregations so that aggregations are formed across multiple different dimensions, such as time or any of a wide variety of other dimensions. Thus, aggregation/prediction models 121 can include multi-dimensional primitive aggregation and prediction model 324, multi-dimensional advanced aggregation and prediction model 326, and other items 328. Model 324 can be a model that performs relatively primitive aggregation, such as first order aggregations generated by a rules-based system. Based on those aggregations (as well as current and historic values), model 324 can generate predictive values as well. Multi-dimensional advanced aggregation and prediction model 326 can generate more advanced aggregations which are based on values derived from the values in the columns being aggregated and predictions for future values can be generated based upon the primitive aggregations, current and historic values, and the more advanced aggregations as well. Thus, models 324 and 326 can be generative AI models such as LLMs, machine learning models, or other models.

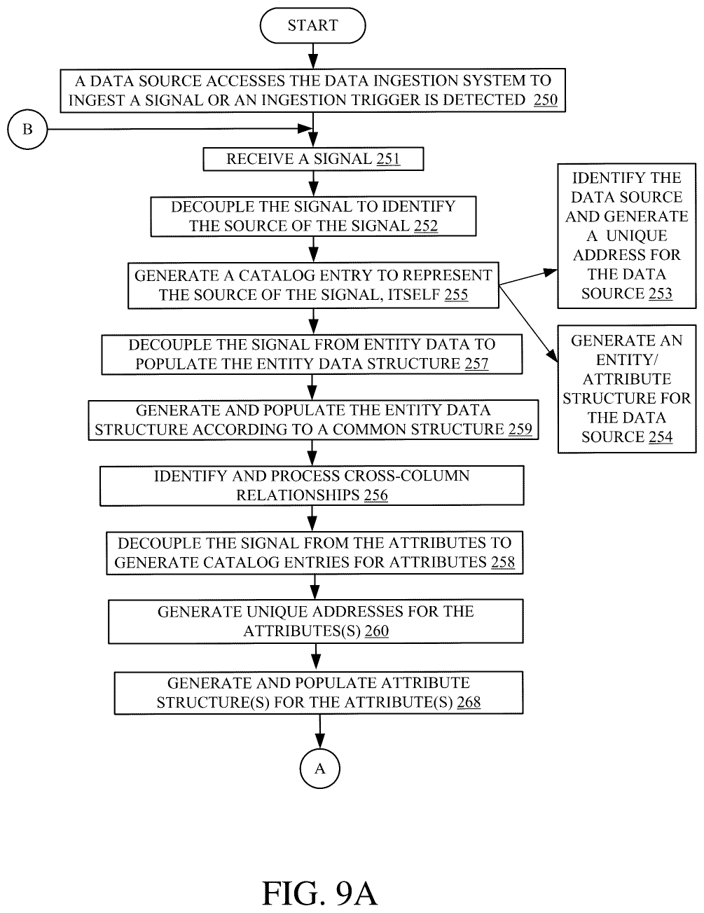

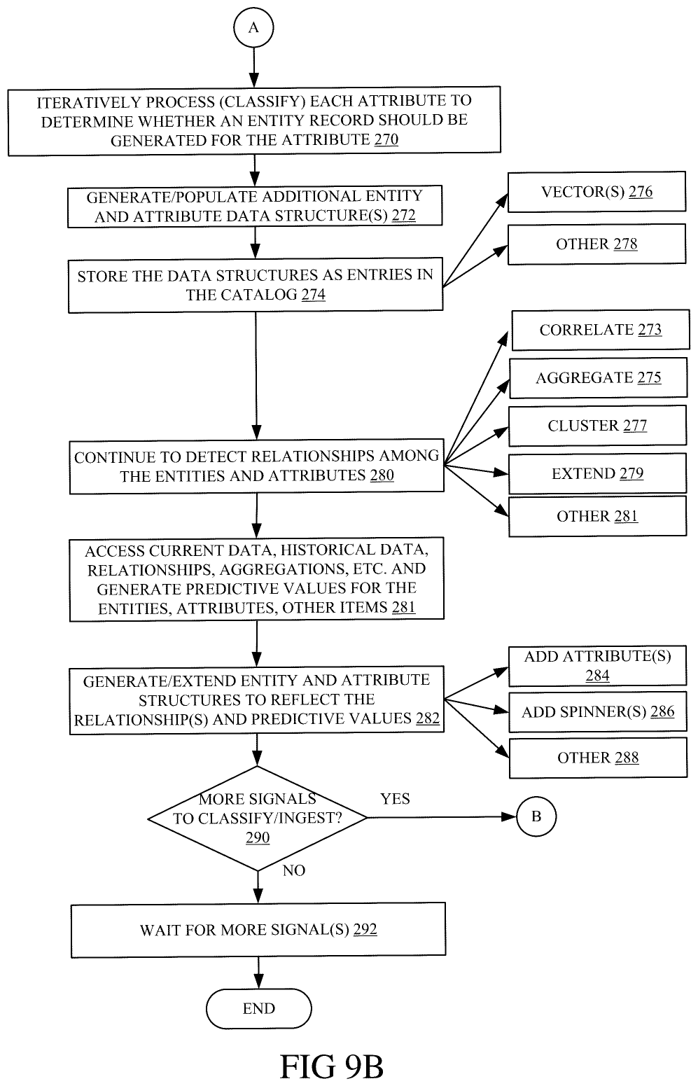

FIGS. 9A and 9B (collectively referred to herein as FIG. 9) show a flow diagram illustrating one example of the operation of mapping and inferencing system architecture 100, in more detail. It is first assumed that a user provides an input to data source selector 133 selecting a data source 102 from which a signal is to be ingested or the data source, itself, indicates that it has a signal that is to be ingested, as indicated by block 250 in the flow diagram of FIG. 9, or another signal ingestion trigger is detected. The trigger can be a manual trigger, or a trigger based on time (e.g., data is ingested periodically or otherwise intermittently), or based on other trigger criteria. Change detector 201 can detect that the signal represents a change to an entity or attribute and this detection can serve as the trigger criteria as well. Detecting a trigger to process signals to ingest data is indicated by block 295. Data source accessing system 134 receives a signal from the data source as indicated by block 251. The signal is decoupled from its metadata and the source of the signal is identified as indicated by block 253, and the source represented in catalog 146 as indicated by block 255. To represent the data source, itself, as a catalog entry in catalog 146. The data source is identified by one or more of the items in data parsing layer 106 and global identification generator 160 generates a unique address for the data source, itself, as indicated by block 252. Signal parsing layer 106 processes the signal and obtains the information used to generate an entity data structure and attribute data structures for the source itself, as indicated by block 254 in the flow diagram of FIG. 9. The entity data structure and attribute data structure(s) representing the data source are then stored as an entry in catalog 146.

Once the data source, itself, is represented as an entity in catalog 146, then data reading and transformation layer 104 continues to process the signal to generate other entities in catalog 146 (which are represented by the signal) according to the common structure. In one example, the entity data is decoupled from the signal and is extracted from the signal by entity extraction system 140. The entity generator 154 generates an entity data structure and populates that data structure with the entity data. Extracting the entity data is indicated by block 257 and generating the entity structure and populating the entity structure is indicated by block 259 on the flow diagram of FIG. 9. As an example of decoupling and extracting the entity data, classification system 138 can generate classification values such as which portions are attributes, which portions are entities, etc., and entity type detector 182 detects the entity type. Owner unique address detector 184 detects the unique address for the owner of the entity. Source unique address detector 186 detects the unique address for the source of the entity. Recency detector 188 detects the last time (and possibly frequency) the entity information was updated (e.g., the beat value), etc. Output generator 192 generates an output indicative of the extracted entity data according to the common structure. Entity generator 154 then generates an entity data structure for the entity and populates the data structure with the extracted entity data. One example of the entity data structure is described above with respect to FIG. 2B. Relationship tracking system 144 identifies relationships with other entities in catalog 146 and performs relationship processing based on the relationships (such as signal processing, message processing, clustering, etc.) as indicated by block 256 in FIG. 9.

As discussed above, signal classification system 138 may be a classifier that is trained to receive an input signal and identify which portions of the input signal correspond to an entity and which portions correspond to attributes of that entity. For instance, a signal representing an object from a data source and its corresponding metadata may be read. By way of example, assume that the object represented by the signal is a table with columns. The object (a table) may be identified as an entity to be included in catalog 146 and the corresponding metadata may be identified as attributes to be included in catalog 146 when an attribute is identified, the signal is decoupled to generate a catalog entry for the attribute(s). Processing the signal decouple it and generate a catalog entry for the attributes is indicated by block 258 in the flow diagram of FIG. 9.

Then, a catalog entry may be generated for each entity and each attribute. Unique address assignment system 180 interacts with global identification generator 160 to generate an IPV6 address or a GUID for the entity and each of the attributes. Generating the unique addresses is indicated by block 260 in the flow diagram of FIG. 9.

As an example, attribute type detector 196 detects the attribute type. Group detector 198 detects the group. Attribute name detector 200 detects or assigns the attribute name. Value detector 202 detects the attribute value. Owner unique address detector 204 and source unique address detector 206 detect the owner and source unique addresses, respectively, and recency detector 208 detects a last time (and perhaps frequency) that the data was updated (e.g., the beat). Output generator 209 generates an output indicative of the attribute data to data structure generation system 108. Attribute generator 156 then generates an attribute data structure (which can be stored in a spinner) for the attributes, according to the common structure, based upon the output from attribute extraction system 142. Generating the attribute data structure is indicated by block 268 in the flow diagram of FIG. 9.

Iteration system 143 then iteratively processes (or classifies) each attribute to determine whether an entity record should be generated for that attribute. For instance, some attributes may also be entities which have their own attributes. Iteratively processing the attributes is indicated by block 270 in the flow diagram of FIG. 9. Data structure generation system 108 then generates any additional entity and attribute data structures, according to the common structure, as indicated by block 272. All of the generated data structures are then stored as entries in catalog 146 in data store 112. Storing the data structures is indicated by block 274. The data structures can be stored as vectors 276 or as other data structures 278.

Analysis system 162 can then access the entries 148-150 in catalog 152, using the relationship information output by relationship tracking system 144 or correlation models 115, or using different models, to identify relationships among the entities and attributes, as indicated by block 280 in the flow diagram of FIG. 9. For instance, correlation models 115 can generate cross-column correlations indicative of relationships 273 among the data structures. Aggregation/prediction models 121 can generate primitive or complex aggregations 275 of values in the data structures as well as predictive values 327. Clustering model(s) 119 can generate clusters 277 based on clustered data output by cross-column clustering system 316 (shown in FIG. 7) or using its own clustering techniques. The analysis can be fed back into data ingestion system 103 to extend catalog 146 by generating new entities and attributes based on the analysis results. Models 115, 119, and 121 can be artificial intelligence (AI) models that read the entries 148-150 and identify relationships, patterns, similarities, correlations, or other information. Detecting such information is indicated by block 280.

Models 121 can access current data in catalog 146, historical data, relationships among catalog entries, aggregations, etc. and generate predictive values for the entries, attributes, and other items. Generating predictive values is indicated by block 281 in FIG. 9.

Based upon the relationships and analysis results, the catalog entries can be modified or extended to reflect the relationships and analysis results, and/or additional data structures can be generated in catalog 146 to reflect the relationships, predictive values, and analysis results. Generating or extending entity and attribute structures to reflect the relationships and analysis results is indicated by block 282 in the flow diagram of FIG. 9. Thus, in one example, an entity can be augmented by adding an attribute indicative of a relationship of the entity with another entity and/or attribute, without disturbing the underlying entity and/or attribute data structures. Adding an attribute is indicated by block 284 in the flow diagram of FIG. 9. An additional spinner (or attribute container) can be added to add the relationships and analysis results as indicated by block 286. The entity and attribute data structures can be generated and extended in other ways as well, to reflect the relationships and analysis results, as indicated by block 288.

When more signals are available to classify and ingest, as determined at block 290, processing reverts to block 251 where the next signal is read. When no more signals are available to read and process, then the system waits for more signals to become available, as indicated by block 292. The catalog 146 can thus represent multiple services, resources, features, products, etc. all using a common data structure. All of the items in the data sources are represented in the same way so that they can be accessed from the catalog 146 using the global unique identifier or the identifier used in the source system.

It should also be noted that users 165 can interact through API 163 with data structure generation system 108 in order to clone and shard or enclave entities and attributes as desired. By way of example, some entities and attributes may be sharded into a separate data shard so that they can be enclaved for purposes of security or for other reasons. Depending on the particular shard and the credentials of user 165, API 163 may present different views to the user. For instance, if user 165 has a first set of credentials, then user 165 may be able to view data shards that contain more protected information. However, if user 165 has a second set of credentials, then user 165 may only be able to view data structures in data shards that include sharable information (e.g., less secure information).

It can thus be seen that the present system allows data from any system to be ingested into a catalog using a data structure which includes a unique address and a value. The information from data sources can be read using common or custom-built reading systems.

Some data structures represent entities while other data structures represent attributes of those entities. The attributes, while having a unique address, themselves, are related to the corresponding entity through that unique address. However, the attributes are standalone data structures within an inventory catalog, as are the entities. The entities and attributes also include identifiers from the source system so that users can access them in the inventory catalog using either the unique address or the identifier from the source system. The attributes and entities can be sharded into protected shards and sharable shards to create multiple controlled catalog views.

It will be noted that the above discussion has described a variety of different systems, components, generators, models, detectors, and/or logic. It will be appreciated that such systems, components, generators, models, detectors, and/or logic can be comprised of hardware items (such as processors and associated memory, or other processing components, some of which are described below) that perform the functions associated with those systems, components, generators, models, detectors, and/or logic. In addition, the systems, components, generators, models, detectors, and/or logic can be comprised of software that is loaded into a memory and is subsequently executed by a processor or server, or other computing component, as described below. The systems, components, generators, models, detectors, and/or logic can also be comprised of different combinations of hardware, software, firmware, etc., some examples of which are described below. These are only some examples of different structures that can be used to form the systems, components, generators, models, detectors, and/or logic described above. Other structures can be used as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

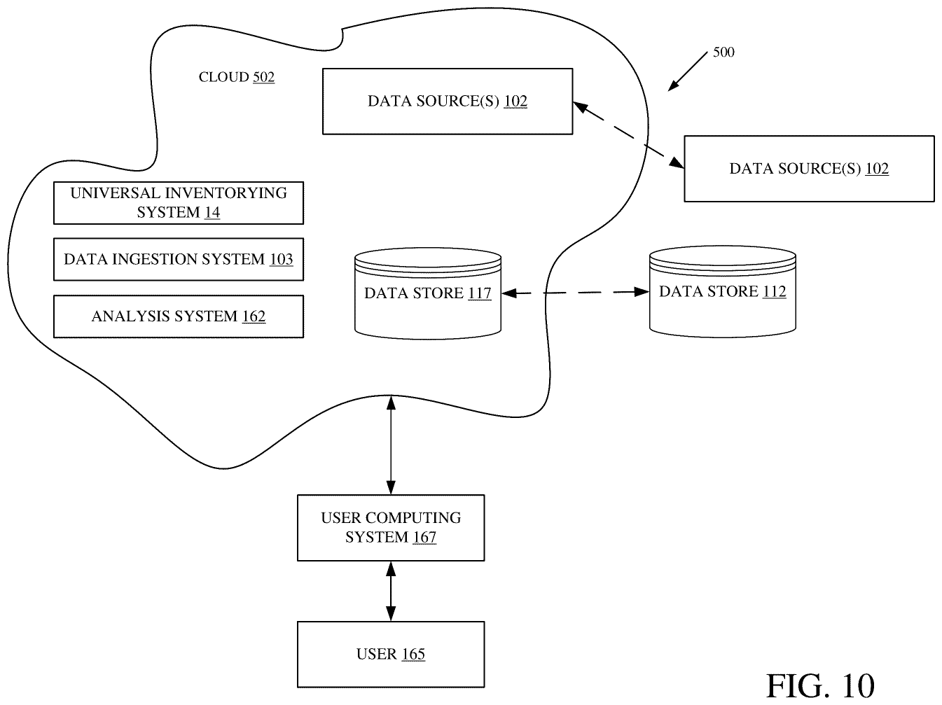

FIG. 10 is a block diagram of architecture 100, shown in FIG. 1D, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, the components and functions can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 10, some items are similar to those shown in FIG. 1D and they are similarly numbered. FIG. 10 specifically shows that data ingestion system 103, data sources 102, data store 117, and/or analysis system 162 can be located in cloud 502 (which can be public, private, or a combination where portions are public while others are private). Therefore, users 165 uses a user computing system 167 to access those systems through cloud 502.

FIG. 10 also depicts another example of a cloud architecture. FIG. 10 shows that it is also contemplated that some elements of architecture 100 can be disposed in cloud 502 while others are not. By way of example, data store 112 can be disposed outside of cloud 502, and accessed through cloud 502. In another example, data source 102 (or other items) can be outside of cloud 502. Regardless of where the items are located, the items can be accessed directly by system 167, through a network (either a wide area network or a local area network), the items can be hosted at a remote site by a service, or the items can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

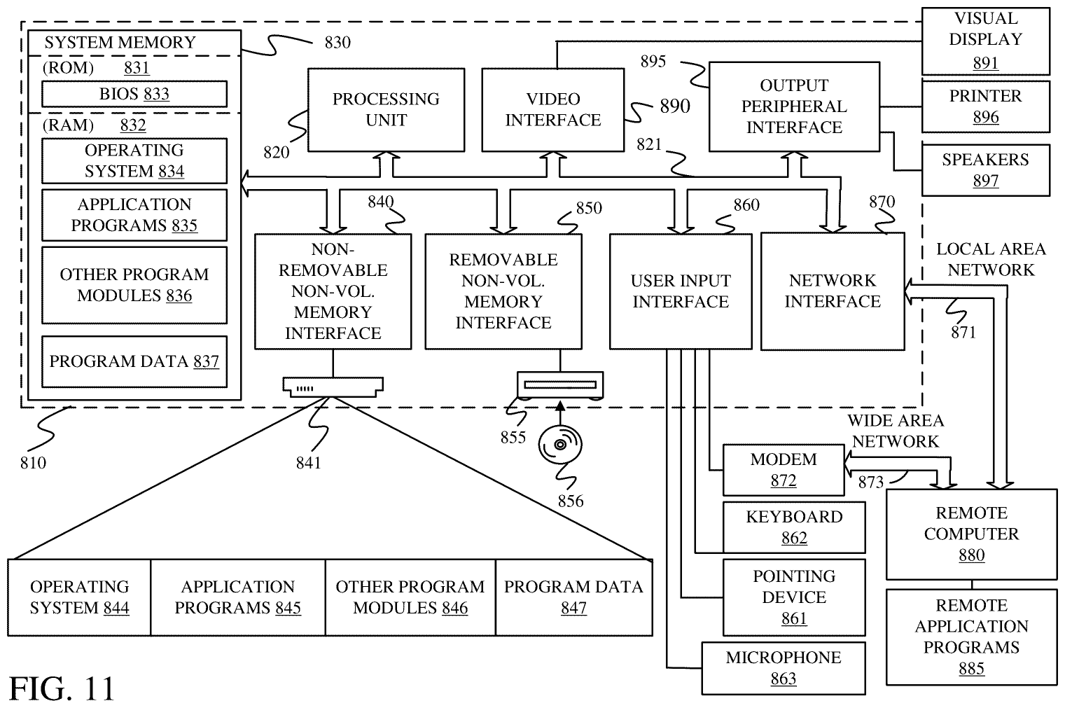

FIG. 11 is one example of a computing environment in which architecture 100, or parts of it, (for example) can be deployed. With reference to FIG. 11, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer implemented method, comprising:
detecting an ingestion trigger identifying a data source from which data is to be ingested;
obtaining entity data indicative of an entity for which data in the data source is to be ingested;
generating an entity data structure as a catalog entry in a catalog;
populating the entity data structure with the entity data including an entity unique address corresponding to the entity;
receiving a data signal from the data source;
classifying the data signal to identify attribute data indicative of an attribute of the entity;
generating an attribute data structure;
populating the attribute data structure with the attribute data, including an attribute unique address corresponding to the attribute, the attribute unique address indicating that the attribute is an attribute of the entity; and
storing the attribute data structure as part of the catalog entry.

Example 2 is The computer implemented method of any or all previous examples and further comprising:
determining whether the attribute is also an entity; and
if so, generating an entity data structure corresponding to the attribute, and populating the entity data structure corresponding to the attribute with the attribute data.

Example 3 is the computer implemented method of any or all previous examples wherein the entity data comprises a source-generated identifier that identifies the entity in the data source and wherein populating the entity data structure comprises:
populating the entity data structure with the source-generated identifier for the entity.

Example 4 is the computer implemented method of any or all previous examples wherein the entity data comprises a source unique address that identifies the data source and wherein populating the entity data structure comprises:
populating the entity data structure with the source unique address.

Example 5 is the computer implemented method of any or all previous examples wherein the attribute data comprises a source-generated identifier that identifies the attribute in the data source and wherein populating the attribute data structure comprises:
populating the attribute data structure with the source-generated identifier.

Example 6 is the computer implemented method of any or all previous examples wherein the attribute data comprises a source unique address that identifies a source of the attribute and wherein populating the attribute data structure comprises:
populating the attribute data structure with the source unique address.

Example 7 is the computer implemented method of any or all previous examples wherein the attribute data comprises an attribute value of the attribute and wherein populating the attribute data structure comprises:
populating the attribute data structure with the attribute value.

Example 8 is the computer implemented method of any or all previous examples wherein the entity data comprises an entity recency value indicative of a recency of the entity data and wherein the attribute data comprises an attribute recency value indicative of a recency of the attribute data and wherein populating the entity data structure comprises populating the entity data structure with the entity recency value and wherein populating the attribute data structure comprises populating the attribute data structure with the attribute recency value.

Example 9 is the computer implemented method of any or all previous examples and further comprising:
classifying the data signal to identify attribute data indicative of an additional attribute of the entity;
generating an additional attribute data structure; and
populating the additional attribute data structure with the attribute data for the additional attribute.

Example 10 is the computer implemented method of any or all previous examples and further comprising:
generating a first attribute container; and
storing the attribute data structure for the attribute and the additional attribute data structure in the attribute container.

Example 11 is the computer implemented method of any or all previous examples and further comprising:
generating a second attribute container; and
storing, in the second attribute container, a subset of attribute data structures stored in the first attribute container.

Example 12 is the computer implemented method of any or all previous examples wherein the catalog has a plurality of entries, and further comprising:
determining whether the attribute value is related to another entity stored in another entity data structure in another catalog entry and, if so:
populating the attribute data structure with another entity unique address from the other entity data structure; and
populating the other entity data structure with the attribute unique address from the attribute data structure.

Example 13 is a computer system, comprising:
an ingestion trigger detector configured to detect an ingestion trigger identifying a data source from which data is to be ingested;
at least one processor configured to obtain entity data indicative of an entity for which data in the data source is to be ingested;
an entity generator, implemented by the at least one processor, configured to generate an entity data structure as a catalog entry in a catalog and populate the entity data structure with the entity data, including an entity unique address corresponding to the entity;
a signal processing platform, implemented by the at least one processor, configured to receive a data signal from the data source and extract attribute data indicative of an attribute of the entity; and
an attribute generator, implemented by the at least one processor, configured to generate an attribute data structure and populate the attribute data structure with the attribute data, including an attribute unique address corresponding to the attribute, the attribute unique address indicating that the attribute is an attribute of the entity, the attribute generator being configured to generate an output to store the attribute data structure as part of the catalog entry.

Example 14 is the computer system of any or all previous examples and further comprising:
a signal classification system configured to receive the attribute data and determine whether the attribute is also an entity, and if so, the entity generator generating an entity data structure corresponding to the attribute and populating the entity data structure corresponding to the attribute with the attribute data.

Example 15 is the computer system of any or all previous examples wherein the entity data comprises a source-generated identifier that identifies the entity in the data source and a source unique address that identifies the data source and wherein the entity generator is configured to populate the entity data structure with the source-generated identifier for the entity and the source unique address.

Example 16 is the computer system of any or all previous examples wherein the attribute data comprises a source-generated identifier that identifies the attribute in the data source, a source unique address that identifies a source of the attribute, and an attribute value of the attribute wherein the attribute generate or is configured to populate the attribute data structure with the source-generated identifier, the source unique address, and the attribute value.

Example 17 is the computer system of any or all previous examples wherein the signal processing platform comprises:
a classifier configured to classify the data signal to identify attribute data indicative of an additional attribute of the entity, the attribute generator being configured to generating an additional attribute data structure, populate the additional attribute data structure with the attribute data for the additional attribute, generate a first attribute container, and store the attribute data structure for the attribute and the additional attribute data structure in the attribute container.

Example 18 is the computer system of any or all previous examples wherein the catalog has a plurality of entries, and further comprising:
a correlation model configured to determine whether the attribute value is related to another entity stored in another entity data structure in another catalog entry and, if so, the attribute generator being configured to populate the attribute data structure with another entity unique address from the other entity data structure and populate the other entity data structure with the attribute unique address from the attribute data structure.

Example 19 is a method, comprising:
generating an entity object with at least one processor, the entity object corresponding to an entity in a source of data, in a data store, the entity object having an entity unique address corresponding to the entity;
classifying a data signal, with a classifier implemented by the at least one processor, from the source of data to identify attribute data indicative of an attribute of the entity; and
generating an attribute object, in the data store, with the attribute data, the attribute data including an attribute unique address corresponding to the attribute and indicating that the attribute is an attribute of the entity.

Example 20 is the method of any or all previous examples and further comprising:
determining whether the attribute is also an entity; and
if so, generating an entity data structure corresponding to the attribute, and populating the entity data structure corresponding to the attribute with a unique address and the attribute data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
detecting an ingestion trigger identifying a data source from which a signal is to be ingested;
obtaining entity data indicative of an entity for which the signal in the data source is to be ingested;
generating an entity data structure as a catalog entry in an electronic catalog;
populating the entity data structure with the entity data including an entity unique address corresponding to the entity;
receiving the signal from the data source;
classifying the signal to identify attribute data indicative of an attribute of the entity;
generating an attribute data structure;
populating the attribute data structure with the attribute data, including an attribute unique address corresponding to the attribute, the attribute unique address indicating that the attribute is an attribute of the entity; and
storing the attribute data structure as part of the catalog entry.

2. The computer implemented method of claim 1 and further comprising:
determining whether the attribute is also an entity; and
if so, generating an entity data structure corresponding to the attribute, and populating the entity data structure corresponding to the attribute with the attribute data.

3. The computer implemented method of claim 1 wherein the entity data comprises a source-generated identifier that identifies the entity in the data source and wherein populating the entity data structure comprises:
populating the entity data structure with the source-generated identifier for the entity.

4. The computer implemented method of claim 3 wherein the entity data comprises a source unique address that identifies the data source and wherein populating the entity data structure comprises:
populating the entity data structure with the source unique address.

5. The computer implemented method of claim 1 wherein the attribute data comprises a source-generated identifier that identifies the attribute in the data source and wherein populating the attribute data structure comprises:
populating the attribute data structure with the source-generated identifier.

6. The computer implemented method of claim 5 wherein the attribute data comprises a source unique address that identifies a source of the attribute and wherein populating the attribute data structure comprises:
populating the attribute data structure with the source unique address.

7. The computer implemented method of claim 6 wherein the attribute data comprises an attribute value of the attribute and wherein populating the attribute data structure comprises:
populating the attribute data structure with the attribute value.

8. The computer implemented method of claim 1 wherein the entity data comprises an entity recency value indicative of a recency of the entity data and wherein the attribute data comprises an attribute recency value indicative of a recency of the attribute data and wherein populating the entity data structure comprises populating the entity data structure with the entity recency value and wherein populating the attribute data structure comprises populating the attribute data structure with the attribute recency value.

9. The computer implemented method of claim 1 and further comprising:
classifying the data signal to identify attribute data indicative of an additional attribute of the entity;
generating an additional attribute data structure; and
populating the additional attribute data structure with the attribute data for the additional attribute.

10. The computer implemented method of claim 9 and further comprising:
generating a first attribute container; and
storing the attribute data structure for the attribute and the additional attribute data structure in the attribute container.

11. The computer implemented method of claim 10 and further comprising:
generating a second attribute container; and
storing, in the second attribute container, a subset of attribute data structures stored in the first attribute container.

12. The computer implemented method of claim 1 wherein the catalog has a plurality of entries, and further comprising:
determining whether the attribute value is related to another entity stored in another entity data structure in another catalog entry and, if so:
populating the attribute data structure with another entity unique address from the other entity data structure; and
populating the other entity data structure with the attribute unique address from the attribute data structure.

13. A computer system, comprising:
an ingestion trigger detector configured to detect an ingestion trigger identifying a data source from which a signal is to be ingested;
at least one processor configured to obtain entity data indicative of an entity for which the signal in the data source is to be ingested;
an entity generator, implemented by the at least one processor, configured to generate an entity data structure as a catalog entry in a computer-implemented catalog and populate the entity data structure with the entity data, including an entity unique address corresponding to the entity;
a signal processing platform, implemented by the at least one processor, configured to receive the signal from the data source and extract attribute data indicative of an attribute of the entity; and
an attribute generator, implemented by the at least one processor, configured to generate an attribute data structure and populate the attribute data structure with the attribute data, including an attribute unique address corresponding to the attribute, the attribute unique address indicating that the attribute is an attribute of the entity, the attribute generator being configured to generate an output to store the attribute data structure as part of the catalog entry.

14. The computer system of claim 13 and further comprising:
a signal classification system configured to receive the attribute data and determine whether the attribute is also an entity, and if so, the entity generator generating an entity data structure corresponding to the attribute and populating the entity data structure corresponding to the attribute with the attribute data.

15. The computer system of claim 13 wherein the entity data comprises a source-generated identifier that identifies the entity in the data source and a source unique address that identifies the data source and wherein the entity generator is configured to populate the entity data structure with the source-generated identifier for the entity and the source unique address.

16. The computer system of claim 13 wherein the attribute data comprises a source-generated identifier that identifies the attribute in the data source, a source unique address that identifies a source of the attribute, and an attribute value of the attribute wherein the attribute generator is configured to populate the attribute data structure with the source-generated identifier, the source unique address, and the attribute value.

17. The computer system of claim 13 wherein the signal processing platform comprises:
a classifier configured to classify the data signal to identify attribute data indicative of an additional attribute of the entity, the attribute generator being configured to generate an additional attribute data structure, populate the additional attribute data structure with the attribute data for the additional attribute, generate a first attribute container, and store the attribute data structure for the attribute and the additional attribute data structure in the attribute container.

18. The computer system of claim 13 wherein the catalog has a plurality of entries, and further comprising:
a correlation model configured to determine whether the attribute value is related to another entity stored in another entity data structure in another catalog entry and, if so, the attribute generator being configured to populate the attribute data structure with another entity unique address from the other entity data structure and populate the other entity data structure with the attribute unique address from the attribute data structure.

19. A method, comprising:
generating an entity object with at least one processor, the entity object corresponding to an entity in a source of data, in a data store, the entity object having an entity unique address corresponding to the entity;
classifying a data signal, with a classifier implemented by the at least one processor, from the source of data to identify attribute data indicative of an attribute of the entity; and
generating an attribute object, in the data store, with the attribute data, the attribute data including an attribute unique address corresponding to the attribute and indicating that the attribute is an attribute of the entity.

20. The method of claim 19 and further comprising:
determining whether the attribute is also an entity; and
if so, generating an entity data structure corresponding to the attribute, and populating the entity data structure corresponding to the attribute with a unique address and the attribute data.
